(19) United States
(12) Patent Application Publication
(10) Pub. No.: US 2026/0063092 A1
(43) Pub. Date: Mar. 5, 2026

(54) Ignition Safety System Loading Confirmation Device and Loading Monitoring System Including the Same

(71) Applicant: AGENCY FOR DEFENSE DEVELOPMENT, Daejeon (KR)

(72) Inventors: Seung Gyo Jang, Daejeon (KR); Joo Young Jin, Daejeon (KR)

(21) Appl. No.: 19/318,555

(22) Filed: Sep. 4, 2025

(30) Foreign Application Priority Data
Sep. 5, 2024 (KR) 10-2024-0120677

(51) Int. Cl. F02K 9/95; F02K 9/56

(52) U.S. Cl. CPC F02K 9/95; F02K 9/566

(57) ABSTRACT

Provided is an ignition safety system arming confirmation device and an arming monitoring system including the same, and more particularly, an electro-mechanical ignition safety system arming confirmation device for ignition of a rocket motor and an arming monitoring system including the same, which provides greater accuracy in detecting an arming status and a safe status by using a permanent magnet and a Hall sensor.

### CROSS-REFERENCE TO RELATED APPLICATION

This application claims priority to Korean Patent Application No. 10-2024-0120677 filed Sep. 5, 2024, the disclosure of which is hereby incorporated by reference in its entirety.

### BACKGROUND

### Technical Field

The following disclosure relates to an ignition safety system arming confirmation device and an arming monitoring system including the same, and more particularly, to an electro-mechanical ignition safety system arming confirmation device for ignition of a rocket motor and an arming monitoring system including the same.

### Technical Considerations

A rocket ignition safety system refers to a device that prevents a guided missile from being accidentally ignited and launched, and launches the guided missile according to a planned launch sequence when a required input condition is satisfied. The rocket ignition safety system follows a design requirement of MIL-STD-1901A, which is a rocket motor ignition system safety standard, and generally has embedded initiators charged with explosives for rocket ignition.

An operating status of the ignition safety system may be classified into a safe status, an arming status, and an ignition status. In general, the safe status refers to a status in which no electric power is supplied to the ignition safety system, and also refers to a status in which the ignition safety system is not only electrically short-circuited, but also includes a mechanical barrier installed therein to prevent ignition energy from being emitted outside the ignition safety system even if the guided missile is accidentally ignited.

The arming status refers to a status in which the mechanical barrier is removed by an externally supplied electric signal or the like, or may be easily removed by an operation of the initiator, and also refers to a status in which the electrical short of the initiator is released and ignition power may be supplied from the outside.

The ignition status refers to a status in which an ignition signal is supplied in the arming status to operate the embedded initiator and emit the ignition energy, which is high-temperature and high-pressure gas, outside the ignition safety system.

The ignition safety system may be classified into mechanical, electric-mechanical, electro-mechanical, or electronic types depending on an arming method.

A prior art related to the electromechanical ignition safety system may provide a more strengthened safety concept and improved reliability by applying an ignition safety circuit, a photo sensor, a through bulkhead initiator (TBI), or the like. The electromechanical ignition safety system may include a safety circuit, a torque motor, a detonator (e.g., an electric detonator), and the through bulkhead initiator. To enhance reliability, two through bulkhead initiators (TBIs) may be disposed in parallel, and an acceptor charge disposed after a donor charge may be sequentially detonated together with a boron potassium nitrate (BKNO₃)-based ignition output charge, thereby forming a final ignition output.

In the electromechanical ignition safety system, the arming status or the safe status may be confirmed by rotating the torque motor and allowing the photo sensor to detect an alignment between the detonator and the through bulkhead initiator (TBI). Wings (or flanges) may be attached to a detonator holder assembly structure. In the safe status, a wingless part may be positioned on the photo sensor and a photodiode may detect light, thereby confirming the safe status. When an arming signal is applied, a detonator holder may rotate and the wings attached to the detonator holder may also rotate to block light from the photodiode, thereby confirming the arming status.

However, the conventional method for confirming the arming status or the safe status by using the photo sensor has an issue in that the wing formed on the detonator may block light from the photodiode and the blocking may be detected as the arming status even when the torque motor rotates only about 20 degrees or more. This configuration may result in another issue in which the arming signal may be generated before the electric detonator and the through bulkhead initiator (TBI) are properly aligned.

### SUMMARY

A non-limiting embodiment of the present disclosure is directed to more accurately detecting an arming status and a safe status by using a permanent magnet and a Hall sensor.

In one non-limiting aspect, provided is an ignition safety system arming confirmation device for a rocket motor, the device including: a torque motor installed inside a housing of an ignition safety system and transmitting rotation power; a detonator holder capable of rotating by a predetermined angle by having a rotation shaft of the torque motor that is inserted thereinto and fixed thereto, and including a pair of wings formed to be symmetrical with each other around the rotation shaft; at least one permanent magnet disposed on an outer wall of the detonator holder and between the pair of wing parts; and a Hall sensor formed by extending to one side of the torque motor, disposed between the pair of wing parts of the detonator holder, and detecting a magnetic flux from the permanent magnet as the detonator holder rotates.

The permanent magnet may include first and second magnet units, and the first and second magnet units may respectively be disposed on first and second side walls formed between a central portion of the detonator holder and an outer circumferential surface of the wing part.

The Hall sensor may include a first Hall sensor unit, and the first Hall sensor unit may be disposed between the first magnet unit and the second magnet unit, and detect a magnetic flux from the first magnet unit or the second magnet unit as the detonator holder rotates.

The first and second magnet units may form the same polarity toward the first Hall sensor unit.

The permanent magnet may further include third and fourth magnet units, and the third and fourth magnet units may respectively be disposed on third and fourth side walls formed between the central portion of the detonator holder and the outer circumferential surface of the wing part, and formed at positions symmetrical with the first and second side walls around the rotation shaft.

The Hall sensor may include a second Hall sensor unit, and the second Hall sensor unit may be disposed between the third magnet unit and the fourth magnet unit, and detect a magnetic flux from the third magnet unit or the fourth magnet unit as the detonator holder rotates.

The third and fourth magnet units may form the same polarity toward the second Hall sensor unit.

In another non-limiting aspect, provided is an ignition safety system arming confirmation device for a rocket motor, the device including: a torque motor installed inside a housing of an ignition safety system and transmitting rotation power; a detonator holder capable of rotating by a predetermined angle by having a rotation shaft of the torque motor that is inserted thereinto and fixed thereto, and including a pair of wings formed to be symmetrical with each other around the rotation shaft and a protrusion extending and protruding in a circumferential direction between the pair of wing parts; at least one permanent magnet disposed in the protrusion and between the pair of wing parts; and a Hall sensor formed by extending to one side of the torque motor, disposed between the pair of wing parts of the detonator holder, and detecting a magnetic flux from the permanent magnet as the detonator holder rotates.

The protrusion may include a first protrusion and a second protrusion, the first protrusion may be formed between the first and second side walls formed between a central portion of the detonator holder and an outer circumferential surface of the wing part and extend in the circumferential direction, and the second protrusion may be formed between the third and fourth side walls formed between the central portion of the detonator holder and the outer circumferential surface of the wing part and extend in the circumferential direction.

The permanent magnet may include first and second magnet units, and the first and second magnet units may be disposed to be spaced apart from the first protrusion.

The Hall sensor may include a first Hall sensor unit, and the first Hall sensor unit may be disposed between the first magnet unit and the second magnet unit, and detect a magnetic flux from the first magnet unit or the second magnet unit as the detonator holder rotates.

The first and second magnet units may form different polarities toward the first Hall sensor unit.

The permanent magnet may include third and fourth magnet units, and the third and fourth magnet units may be disposed to be spaced apart from the second protrusion.

The Hall sensor may include a second Hall sensor unit, and the second Hall sensor unit may be disposed between the third magnet unit and the fourth magnet unit, and detect a magnetic flux from the third magnet unit or the fourth magnet unit as the detonator holder rotates.

The third and fourth magnet units may form different polarities toward the second Hall sensor unit.

The permanent magnet may have a cylindrical shape having a diameter of 2 mm and a height of 2 mm.

Other features and aspects will be apparent from the following detailed description, the drawings, and the claims.

### BRIEF DESCRIPTION OF THE DRAWINGS

FIG. 1 is a perspective view showing one side of an arming confirmation device according to a non-limiting embodiment of the present disclosure.

FIG. 2 is a perspective view showing one side of the arming confirmation device including a protrusion according to a non-limiting embodiment of the present disclosure.

FIG. 3 is a front view showing a positional relationship among a detonator holder, a permanent magnet, and a Hall sensor when the arming confirmation device is in a safe status according to a non-limiting embodiment of the present disclosure.

FIG. 4 is a front view showing the positional relationship between the detonator holder, the permanent magnet, and the Hall sensor when the arming confirmation device is in an arming status according to a non-limiting embodiment of the present disclosure.

FIG. 5 is a circuit diagram showing a monitoring system including an arming confirmation device according to a non-limiting embodiment of the present disclosure.

### DETAILED DESCRIPTION

The above-mentioned purposes, features, and advantages will become more apparent from the following embodiments provided in relation to the accompanying drawings. The following descriptions of specific structures and functions are provided only as examples to describe the embodiments based on a concept of the present disclosure. Therefore, the embodiments of the present disclosure may be implemented in various forms, and the present disclosure should not be construed as being limited to the embodiments described in this specification or application. The embodiments of the present disclosure may be variously modified and have several forms, and specific embodiments are thus shown in the accompanying drawings and described in detail in this specification or application. However, it should be understood that the present disclosure is not limited to the specific embodiments, and includes all modifications, equivalents, and substitutions included in the spirit and scope of the present disclosure. Terms such as “first” or “second” may be used to describe various components, and the components are not to be construed as being limited to the terms. The terms are used only to distinguish one component and another component from each other. For example, a “first” component may be named a “second” component and the “second” component may also be named the “first” component, without departing from the scope of the present disclosure. It should be understood that when one component is referred to as being connected to or coupled to another component, one component may be connected or coupled directly to another component or be connected or coupled to another component with yet another component interposed therebetween. On the other hand, it should be understood that when one component is referred to as being connected directly to or coupled directly to another component, one component may be connected or coupled to another component without yet another component interposed therebetween. Other expressions to describe a relationship between the components, i.e., “˜between” and “directly between” or “adjacent to” and “directly adjacent to”, should be interpreted in the same manner as above. Terms used in this specification are used only to describe the specific embodiments rather than limit the disclosure. A term of a singular number may include its plural number unless explicitly indicated otherwise in the context. It should be understood that terms “include”, “have”, or the like, used in this specification specify the presence of features, numerals, steps, operations, components, parts, or a combination thereof stated in this specification, but do not preclude the presence or addition of one or more other features, numerals, steps, operations, components, parts, or a combination thereof. Unless otherwise defined, all terms used herein, including technical or scientific terms, have the same meanings as those generally understood by those skilled in the art to which the present disclosure pertains. Terms generally used and defined in a dictionary should be interpreted as the same meanings as those within the context of the related art, and should not be interpreted as ideal or excessively formal meanings unless clearly indicated in this specification. Hereinafter, the present disclosure will be described in detail by describing a non-limiting embodiment of the present disclosure with reference to the accompanying drawings. The same reference numerals in each drawing indicate the same member.

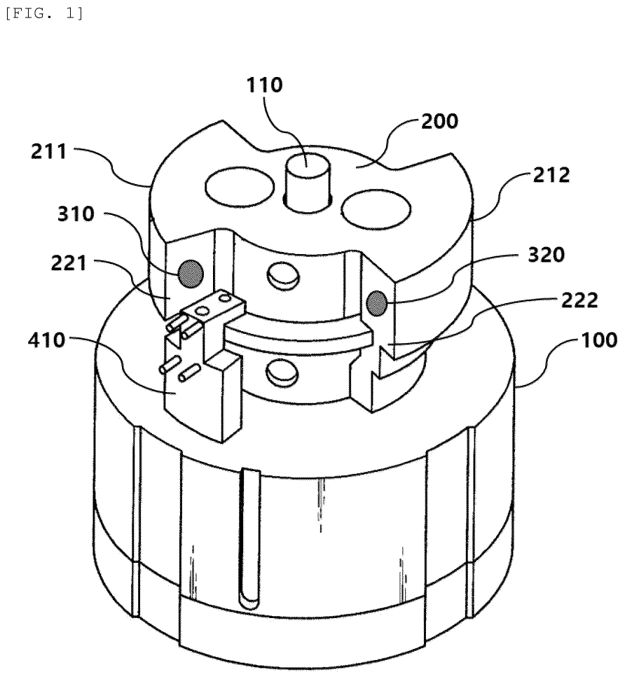

FIG. 1 is a perspective view showing one side of an arming confirmation device according to a non-limiting embodiment of the present disclosure.

Referring to FIG. 1, the arming confirmation device according to a non-limiting embodiment of the present disclosure may include a torque motor 100, a detonator holder 200, permanent magnets 310 and 320, and a Hall sensor 410.

The torque motor 100 may be installed inside a housing of an ignition safety system and may transmit rotation power. The torque motor 100 may be an electromagnetic actuator that provides a limited-angle torque and may convert an electric signal into a limited rotation of a rotor. The torque motor 100 may include a rotation shaft 110, a stator, a rotor case, and a coil. A rotation angle of the torque motor 100 may vary depending on the number of poles, and in a case of two poles, the torque motor 100 may have a rotation angle of up to ±90° in a mechanical angle. When arming power is applied to the torque motor 100, the torque motor 100 may be switched to an arming status within several tens of milliseconds, thereby aligning an electric detonator and a charge of a through bulkhead initiator.

The detonator holder 200 may serve to support the electric detonator, and the electric detonator may be installed inside the detonator holder 200. The electric detonator may transmit energy for detonating the through bulkhead initiator. The rotation shaft 110 of the torque motor 100 may be inserted into and fixed to the central portion of the detonator holder 200. By rotating the torque motor 100, the detonator holder 200 may be rotated by a predetermined angle together with the torque motor 100, and as the detonator holder 200 is rotated by the predetermined angle, a mutual position between the detonator holder 200 and the through bulkhead initiator may be determined. In addition, the detonator holder 200 may include a pair of wing parts 211 and 212 formed to be symmetrical with each other around the central portion into which the rotation shaft 110 is inserted.

The permanent magnet 310 or 320 may be disposed on an outer wall of the detonator holder 200 and between the pair of wing parts 211 and 212. The permanent magnets 310 and 320 may include a first magnet unit 310 and a second magnet unit 320. The first magnet unit 310 may be disposed on a first side wall 221 formed between an outer circumferential surface of the first wing part 211 and the central portion, and the second magnet unit 320 may be disposed on a second side wall 222 formed between an outer circumferential surface of the second wing part 212 and the central portion, respectively. In addition, the permanent magnet may include a third magnet unit and a fourth magnet unit, which are not shown in the drawing. The third magnet unit and the fourth magnet unit may be formed on a third side wall and a fourth side wall to be symmetrical with each other around the central portion into which the rotation shaft 110 is inserted. Here, the first magnet unit 310 and the second magnet unit 320 may form the same polarity (north (N) pole or south(S) pole), and the third magnet unit and the fourth magnet unit may also form the same polarity (the N pole or the S pole). In addition, the permanent magnet may be a cylindrical small permanent magnet having a diameter of 2 mm and a height of 2 mm in order to reduce a weight of the detonator holder 200.

The Hall sensor 410 may be formed by extending to one side of the torque motor 100, be disposed between the pair of wing parts 211 and 212 of the detonator holder 200, and detect a magnetic flux from the permanent magnet 310 or 320 as the detonator holder 200 rotates. The Hall sensor 410 may include a first Hall sensor unit 410 and a second Hall sensor unit (not shown), and the first Hall sensor unit 410 may be disposed between the first magnet unit 310 and the second magnet unit 320, and the second Hall sensor unit may be disposed between the third magnet unit and the fourth magnet unit. Accordingly, the first Hall sensor unit 410 may detect the magnetic flux from the first magnet unit 310 or the second magnet unit 320 as the detonator holder 200 rotates.

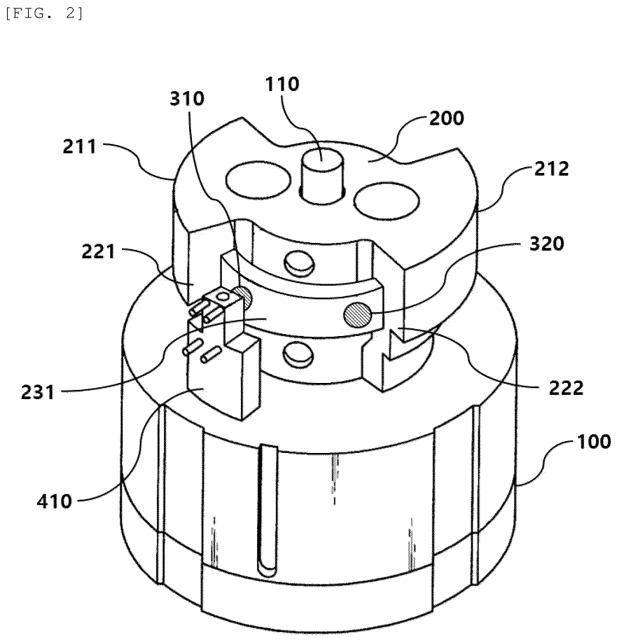

FIG. 2 is a perspective view showing one side of the arming confirmation device including a protrusion according to a non-limiting embodiment of the present disclosure.

Referring to FIG. 2, the detonator holder 200 may further include a protrusion 231.

The protrusion 231 may be formed between the pair of wing parts 211 and 212, and may include the first protrusion 231 and a second protrusion (not shown) formed at a position symmetrical with the first protrusion 231 around the central portion into which the rotation shaft 110 is inserted. The first protrusion 231 may be formed by extending to be in contact with the first and second side walls, and the second protrusion (not shown) may be formed by extending to be in contact with the third and fourth side walls.

Here, the permanent magnets 310 and 320 may be disposed in the protrusion 231 of the detonator holder 200. That is, the first magnet unit 310 and the second magnet unit 320 may be disposed in the first protrusion 231, and the third magnet unit and the fourth magnet unit may be disposed in the second protrusion. The first magnet unit 310 and the second magnet unit 320 disposed in the first protrusion 231 may form different polarities. For example, if the first magnet unit 310 forms the S pole toward the Hall sensor 410, the second magnet unit 320 may form the N pole toward the Hall sensor 410.

The Hall sensor 410 may include the first Hall sensor unit 410 and the second Hall sensor unit (not shown). The first Hall sensor unit 410 may be disposed between the first magnet unit 310 and the second magnet unit 320 to detect the magnetic flux from the first magnet unit 310 or the second magnet unit 320 as the detonator holder 200 rotates. The second Hall sensor unit may also be disposed between the third magnet unit and the fourth magnet unit and detect a magnetic flux from the third magnet unit or the fourth magnet unit as the detonator holder 200 rotates.

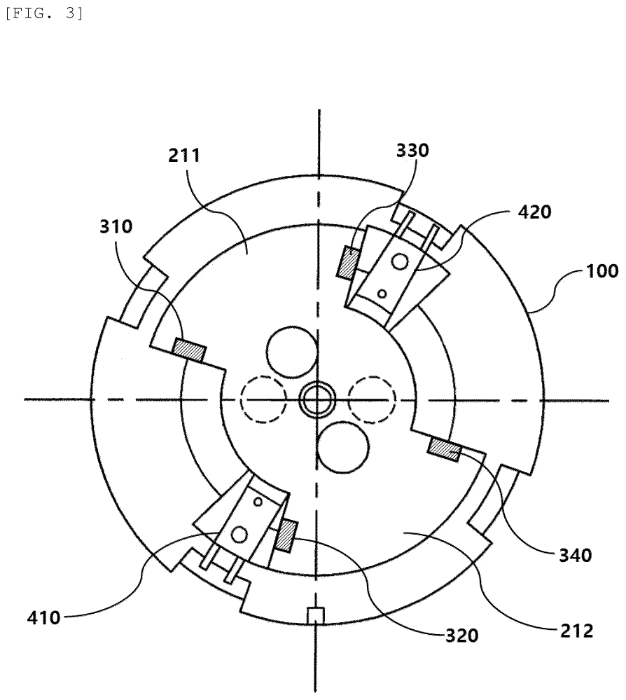

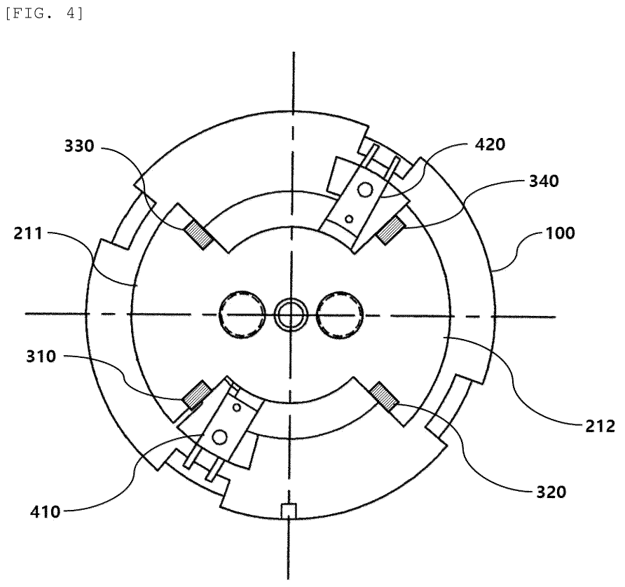

FIG. 3 is a front view showing a positional relationship among the detonator holder, the permanent magnet, and the Hall sensor when the arming confirmation device is in a safe status according to a non-limiting embodiment of the present disclosure, and FIG. 4 is a front view showing the positional relationship between the detonator holder, the permanent magnet, and the Hall sensor when the arming confirmation device is in the arming status according to a non-limiting embodiment of the present disclosure.

Referring to FIGS. 3 and 4, the safe status refers to a status in which the electric detonator of the detonator holder 200 and a donor charge of the through bulkhead initiator are not aligned with each other, and the electric detonator and the donor charge are not aligned to thus be blocked by an internal through bulkhead of the through bulkhead initiator (see FIG. 3). Here, the first Hall sensor unit 410 may be in contact with the second magnet unit 320, and a second Hall sensor unit 420 may be in contact with a third magnet unit 330. In an initial safe status, the first Hall sensor unit 410 and the second Hall sensor unit 420 may detect the magnetic flux from the second magnet unit 320 and the third magnet unit 330, respectively.

The arming status refers to a status in which the electric signal may be received from the outside to enable detonation of the through bulkhead initiator. When direct current (DC) power is applied to the torque motor 100, the torque motor 100 may rotate by the predetermined angle, and the detonator holder 200 coupled to the torque motor 100 may rotate by the angle to align the electric detonator with the through bulkhead initiator. Here, the first Hall sensor unit 410 may detect the magnetic flux from the first magnet unit 310, and the second Hall sensor unit 420 may detect the magnetic flux from a fourth magnet unit 340. The first Hall sensor unit 410 and the second Hall sensor unit 420 may detect opposite polarities based on surfaces of the Hall sensor units, and thus detect the rotation of the detonator holder 200, i.e., the arming status.

In addition, FIGS. 3 and 4 show a distance between the Hall sensor and the permanent magnet in the safe status and the arming status, respectively. When the distance between the first Hall sensor unit 410 and the second magnet unit 320 in the safe status is D1, and when the distance between the first Hall sensor unit 410 and the first magnet unit 310 in the arming status is D2, D1 may be smaller than D2. Here, the distance standard between the permanent magnet and the Hall sensor refers to a distance from a surface of the permanent magnet to a detection surface of the Hall sensor.

For example, D1 may be 0.937 mm and D2 may be 2.5 mm. A magnetic flux density of 12 millitesla (mT) or more may be required to switch the first Hall sensor unit 410 to the arming status (ON status), and a magnetic flux density of 1 mT or less may be required to return the first Hall sensor unit 410 to the safe status (OFF status). Therefore, when the torque motor 100 rotates by the arming signal to dispose the first Hall sensor unit 410 to be close to the first magnet unit 310, the magnetic flux density of 12 mT or more may be applied to the first Hall sensor unit 410 to switch the first Hall sensor unit 410 to the ON status. When the arming signal is blocked, the detonator holder 200 may return to its original position to dispose the first Hall sensor unit 410 to be close to the second magnet unit 320, the opposite polarity may thus be applied thereto based on the surface of the Hall sensor unit, and a negative magnetic flux density may be applied to the first Hall sensor unit 410. It is apparent that the second Hall sensor unit 420, the third magnet unit 330, and the fourth magnet unit 340 are operated in the same manner.

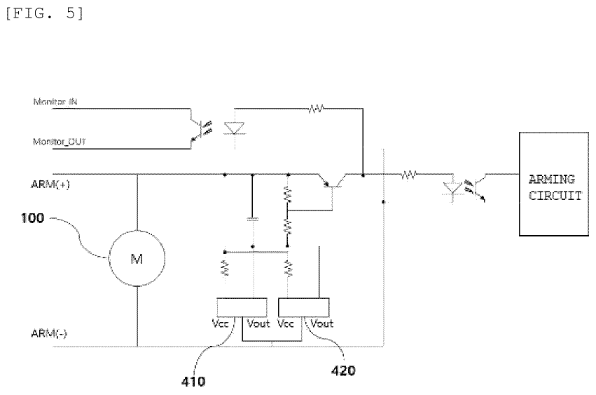

FIG. 5 is a circuit diagram showing a monitoring system including an arming confirmation device according to a non-limiting embodiment of the present disclosure.

Referring to FIG. 5, the monitoring system including an arming confirmation device may include two Hall sensors, i.e., the first Hall sensor unit 410 and the second Hall sensor unit 420, which are connected in parallel with a monitoring device. When an electrical arming signal is applied, the detonator holder 200 assembled to the rotation shaft 110 may rotate by the operation of the torque motor 100 to switch an ignition safety device to the arming status. A change in a magnetic field generated by the rotation of the first to fourth magnet units 310, 320, 330, and 340 installed in the detonator holder 200 may be detected by the first and second Hall sensor units 410 and 420, and a detonation circuit may be activated when a switch connected to the detonation circuit is turned on. Here, the first Hall sensor unit 410 and the second Hall sensor unit 420 that operate the switch may be disposed in parallel, thereby duplicating the arming detection based on the rotation of the torque motor 100 and improving monitoring reliability. In addition, the signal supplied to the first and the second Hall sensor units 410 and 420 may be utilized as the arming signal for activating a connected arming circuit, thereby simultaneously implementing mechanical arming and electrical arming.

As set forth above, according to the present disclosure, the safe status and the arming status may be detected more accurately by using the permanent magnet and the Hall sensor.

In addition, according to the present disclosure, the reliability may be improved by disposing the permanent magnet and the Hall sensor in both directions.

In addition, according to the present disclosure, the mechanical arming and the electrical arming may be implemented simultaneously by utilizing the signal supplied from the Hall sensor as the arming signal for activating the connected ignition circuit.

Although the embodiments of the present disclosure are shown and described as above, the embodiments of the present disclosure are not intended to limit the spirit of the present disclosure, but rather to describe the same. Accordingly, the spirit of the present disclosure includes not only each disclosed embodiment but also combinations of the disclosed embodiments. Furthermore, the scope of the present disclosure is not limited to these embodiments. In addition, the present disclosure may be variously changed and modified by those skilled in the art to which the present disclosure pertains without departing from the spirit and scope of the appended claims, and all such appropriate changes and modifications should be considered equivalent and fall within the scope of the present disclosure.

What is claimed is:

1. An ignition safety system arming confirmation device for a rocket motor, the device comprising:
a torque motor installed inside a housing of an ignition safety system and transmitting rotation power;
a detonator holder capable of rotating by a predetermined angle by having a rotation shaft of the torque motor that is inserted thereinto and fixed thereto, and comprising a pair of wings formed to be symmetrical with each other around the rotation shaft;
at least one permanent magnet disposed on an outer wall of the detonator holder and between the pair of wing parts; and
a plurality of Hall sensors formed by extending to one side of the torque motor, disposed between the pair of wing parts of the detonator holder, and detecting a magnetic flux from the permanent magnet as the detonator holder rotates.

2. The device of claim 1, wherein the permanent magnet comprises first and second magnet units, and
the first and second magnet units are respectively disposed on first and second side walls formed between a central portion of the detonator holder and an outer circumferential surface of the wing part.

3. The device of claim 2, wherein the Hall sensor comprises a first Hall sensor unit, and
the first Hall sensor unit is disposed between the first magnet unit and the second magnet unit, and detects a magnetic flux from the first magnet unit or the second magnet unit as the detonator holder rotates.

4. The device of claim 3, wherein the first and second magnet units form the same polarity toward the first Hall sensor unit.

5. The device of claim 2, wherein the permanent magnet further comprises third and fourth magnet units, and
the third and fourth magnet units are respectively disposed on third and fourth side walls formed between the central portion of the detonator holder and the outer circumferential surface of the wing part, and formed at positions symmetrical with the first and second side walls around the rotation shaft.

6. The device of claim 5, wherein the Hall sensor comprises a second Hall sensor unit, and
the second Hall sensor unit is disposed between the third magnet unit and the fourth magnet unit, and detects a magnetic flux from the third magnet unit or the fourth magnet unit as the detonator holder rotates.

7. The device of claim 6, wherein the third and fourth magnet units form the same polarity toward the second Hall sensor unit.

8. An ignition safety system arming confirmation device for a rocket motor, the device comprising:
a torque motor installed inside a housing of an ignition safety system and transmitting rotation power;
a detonator holder capable of rotating by a predetermined angle by having a rotation shaft of the torque motor that is inserted thereinto and fixed thereto, and comprising a pair of wings formed to be symmetrical with each other around the rotation shaft and a protrusion extending in and protruding a circumferential direction between the pair of wing parts;
at least one permanent magnet disposed in the protrusion and between the pair of wing parts; and
a plurality of Hall sensors formed by extending to one side of the torque motor, disposed between the pair of wing parts of the detonator holder, and detecting a magnetic flux from the permanent magnet as the detonator holder rotates.

9. The device of claim 8, wherein the protrusion comprises a first protrusion and a second protrusion,
the first protrusion is formed between the first and second side walls formed between a central portion of the detonator holder and an outer circumferential surface of the wing part and extends in the circumferential direction, and
the second protrusion is formed between the third and fourth side walls formed between the central portion of the detonator holder and the outer circumferential surface of the wing part and extends in the circumferential direction.

10. The device of claim 9, wherein the permanent magnet comprises first and second magnet units, and
the first and second magnet units are disposed to be spaced apart from the first protrusion.

11. The device of claim 10, wherein the Hall sensor comprises a first Hall sensor unit, and
the first Hall sensor unit is disposed between the first magnet unit and the second magnet unit, and detects a magnetic flux from the first magnet unit or the second magnet unit as the detonator holder rotates.

12. The device of claim 11, wherein the first and second magnet units form different polarities toward the first Hall sensor unit.

13. The device of claim 9, wherein the permanent magnet comprises third and fourth magnet units, and
the third and fourth magnet units are disposed to be spaced apart from the second protrusion.

14. The device of claim 13, wherein the Hall sensor comprises a second Hall sensor unit, and
the second Hall sensor unit is disposed between the third magnet unit and the fourth magnet unit, and detects a magnetic flux from the third magnet unit or the fourth magnet unit as the detonator holder rotates.

15. The device of claim 14, wherein the third and fourth magnet units form different polarities toward the second Hall sensor unit.

16. The device of claim 1, wherein the permanent magnet has a cylindrical shape having a diameter of 2 mm and a height of 2 mm.

17. An arming monitoring system comprising an ignition safety system for a rocket motor, the system comprising:
an arming confirmation device according to claim 1; and
a monitoring device connected to the arming confirmation device and monitoring an arming status of the rocket motor by using a plurality of Hall sensors included in the arming confirmation device,
wherein each of the plurality of Hall sensors is connected in parallel with the monitoring device.

18. The system of claim 17, wherein
the permanent magnet comprised in the arming confirmation device comprises first and second magnet units, and
the first and second magnet units are disposed to be spaced apart from the first protrusion.

19. The system of claim 17, wherein
the Hall sensor comprised in the arming confirmation device comprises a first Hall sensor unit, and
the first Hall sensor unit is disposed between the first magnet unit and the second magnet unit, and detects a magnetic flux from the first magnet unit or the second magnet unit as the detonator holder rotates.
